(19) United States
(12) Patent Application Publication
(10) Pub. No.: US 2017/0189977 A1
(43) Pub. Date: Jul. 6, 2017

(54) VARIABLE SPEED REVERSIBLE METAL DETECTING SAW MILL SYSTEM

(71) Applicant: Brian Read, Milwaukee, WI (US)

(72) Inventor: Brian Read, Milwaukee, WI (US)

(21) Appl. No.: 15/159,914

(22) Filed: May 20, 2016

Related U.S. Application Data
(63) Continuation-in-part of application No. 14/997,776, filed on Jan. 18, 2016, now abandoned.
(60) Provisional application No. 62/274,645, filed on Jan. 4, 2016.

(51) Int. Cl. B23D 59/00; B23D 61/02

(52) U.S. Cl. CPC B23D 59/005; B23D 61/025

(57) ABSTRACT

A perpendicular axis saw blade includes a blade body with an outer blade body edge to which a plurality of primary saw teeth are affixed at spaced intervals to form a primary teeth per inch (TPI). The blade also includes a plurality of primary gullets. Each primary gullet is located between two of the plurality of primary teeth and has a primary gullet depth and primary gullet capacity. Each of the plurality of the primary teeth includes a primary tooth tip, a primary tooth leading edge, a primary tooth trailing edge. Secondary saw teeth affixed at spaced intervals to the primary tooth trailing edge or at least one primary gullet form a secondary TPI. The primary teeth cut a workpiece during a machining operation. A user or system can use the secondary teeth to cut through a foreign object detected in the workpiece without damaging any primary teeth.

### CROSS-REFERENCE TO RELATED APPLICATIONS

This patent application claims the benefit of U.S. Provisional Application No. 62/274,645 filed Jan. 4, 2016. This application is a continuation-in-part of U.S. application Ser. No. 14/997,776 filed Jan. 18, 2016. The above applications are incorporated by reference herein in their entirety.

### BACKGROUND OF THE INVENTION

1. Field of Invention

The present invention relates to the field of cutting and subtractive manufacturing, and more specifically to an optimized saw blade and sawmill apparatus for use in milling operations that cut materials along a perpendicular, moving saw axis.

2. Description of Related Art

Subtractive manufacturing refers to machining processes in which a piece of raw material, such as wood or metal, is cut into a desired final shape and size by a controlled material-removal process.

Milling is a controlled material-removal process that typically uses bandsaws or rotary saws to remove portions of material by advancing (or feeding) a workpiece to come into come into contact with cutting teeth positioned on an oscillating or rotating saw blade. The saw blade is typically a bandsaw blade or a circular saw blade.

During a milling operation, the cutting surface on the tip of each saw blade tooth penetrates the workpiece, pushing, shaving or shearing off a continuous chip of material as the tooth moves. This chip remains in the gullet, the space between the tooth tip and the inner surface of the blade. Once the tooth is free from the workpiece, the chip falls away from the gullet, freeing the tooth to cut away another chip during the next oscillation or rotation.

A defining characteristic of a milling apparatus is that the workpiece moves perpendicular to the axis of movement of the bandsaw and circular saw blades. A further defining characteristic of milling is the precise geometry of the saw blade teeth, which have a cutting surface and curvature that simultaneously cuts into the work piece and removes material in carefully controlled manner to perform precise shearing.

Milling systems have become increasing sophisticated with the integration of computer numerical control (CNC) technologies. Many systems incorporate multiple milling functions, and include sensors to monitor the status of the cutting tools and the workpieces. Many attempts have been made in the prior art to increase throughput (feed rate) without damaging saw blade components and causing system down time and error due to damage to the saw blades.

There are several factors that affect cutting efficiency: saw blade and tooth design, band speed, feed and gullet capacity.

Saw blades must be carefully engineered, drawing upon material science concepts and a large body of research as to the relationship of tooth geometry and the materials being cut. Saw tooth geometry is highly specific to the type of material being cut. Furthermore, the size and shape of the material to be cut dictates the blade's teeth per inch (TPI) for the material.

Blades can be made from one piece of steel, or built up of two pieces, depending on the performance and life expectancy required. A hard back saw blade is a one-piece blade made of carbon steel with a hardened back and tooth edge. A flex back saw blade is a one-piece blade made of carbon steel with a hardened tooth edge and soft back. A bi-metal saw blade is a high-speed steel edge material that has been electron beam welded to a fatigue resistant spring steel backing. Such a design provides better cutting performance in certain situations.

Increased band speed increases cutting efficiency. Efficient cutting removes as much material as possible as quickly as possible by using as high a band speed as the machine can handle. Band speed is restricted, however, by the machinability of the material and how much heat the cutting action produces. Too high a band speed or very hard materials produce excessive heat, resulting in reduced blade life and potential damage to the workpiece.

Feed refers to the depth of penetration of the saw blade tooth into the material being cut. However, the machinability of the material being cut and blade life expectancy limits the feed. A deeper feed results in a lower shear plane angle (angle at which the chip shears off) and faster cutting, but dramatically reduced blade life. A light feed increases the blade life, but also increase the shear plane angle and decreases cutting efficiency.

Gullet capacity also affects cutting efficiency. As the tooth scrapes away the material during a cut, the chip curls up into the gullet. A blade with the proper clearance for the cut allows the chip to curl up uniformly and fall away from the gullet. If too much material is scraped away, the chip will jam into the gullet area causing increased resistance. This loads down the machine, wastes energy and can cause damage to the blade.

It is a problem known in the art that even brief contract of a woodcutting saw blade with metal during a wood milling operation could cause significant damage to the blade, as well as substantial downtime for a milling facility. In theory, such damage can occur from any foreign material embedded in the wood. Furthermore, such damage can also occur in operations cutting other substances, such as metal or cork, when a saw blade encounters foreign objects in the workpiece.

Attempts have been made to mitigate this damage, such as use of sensors. One design uses a sensor embedded in the surface supporting the workpiece to detect metal before it comes into contact with the saw blade. However, if the workpiece is too thick for accurate detection or the metal does not properly align with the sensor, detection may not occur in time to prevent damage to the blade.

There is an unmet need for technology that can protect milling systems from costly damage caused by undetected, embedded objects made of metal and other materials that damage specialized saw blades.

There is a further need for more versatile and durable saw blades than those that are currently known in the art.

### BRIEF SUMMARY OF THE INVENTION

One embodiment of the present invention is a perpendicular axis saw blade. The blade includes a blade body having an outer blade body edge to which a plurality of primary saw teeth are affixed at spaced intervals to form a primary teeth per inch (TPI). The blade also includes a plurality of primary gullets. Each primary gullet is located between two of the plurality of primary saw teeth and has a primary gullet depth and primary gullet capacity. Each of the plurality of the primary saw teeth includes a primary tooth tip, a primary tooth leading edge and a primary tooth trailing edge. A plurality of secondary saw teeth affixed to the primary tooth trailing edge at spaced intervals form a secondary TPI.

One embodiment of the present invention is a perpendicular axis saw blade. The blade includes a blade body having an outer blade body edge to which a plurality of primary saw teeth are affixed at spaced intervals to form a primary teeth per inch (TPI). The blade also includes a plurality of primary gullets. Each primary gullet is located between two of the plurality of primary saw teeth and has a primary gullet depth and primary gullet capacity. Each of the plurality of the primary saw teeth includes a primary tooth tip, a primary tooth leading edge and a primary tooth trailing edge. A plurality of secondary saw teeth affixed to the primary tooth trailing edge at spaced intervals form a secondary TPI.

Another embodiment of the present invention is a perpendicular axis saw system for performing subtractive machining on a workpiece. The system includes at least one material sensor for determining the presence of a foreign object within a workpiece and at least one computer control component. The material sensor is configured to transmit at least one alert signal when a foreign object has been detected within the workpiece. The computer control component is configured to receive or process the at least one alert signal from the at least one material sensor and to perform at least one saw blade control function to control operation of a perpendicular axis saw blade (as detailed above).

### BRIEF DESCRIPTION OF SEVERAL VIEWS OF THE DRAWING(S)

FIGS. 1a-1d illustrate alternate embodiments of a perpendicular axis saw blade.

FIG. 2 illustrates an exemplary embodiment of a perpendicular axis saw system.

FIG. 3 illustrates an exemplary method for using the perpendicular axis saw system.

### TERMS OF ART

As used herein, the term “alternate” means a saw blade design where every tooth is set in an alternating sequence. Used for quick removal of material when finish is not critical.

As used herein, the term “blade body” means the body of the blade not including tooth portion.

As used herein, the term “clearance angle” means the angle between the tooth back and the axis of motion of the saw blade.

As used herein, the term “control operation” refers to an operation or function performed by a computer processor or control unit to alter, analyze or measure the movement, operation, state or function of a mechanical part.

As used herein, the term “direction of movement” refers to the course of motion of a component (e.g. axial, rotational, etc.)

As used herein, the term “feed” or “feed rate” refers to the depth of penetration of the tooth into the material being cut. Variables affecting feed or feed rate may include but are not limited to the type material being cut, the saw blade material, blade life expectancy or optimization.

As used herein, the term “foreign object” refers to an object located at least partially within a workpiece and having a composition different from said workpiece.

As used herein, the term “gullet” means the curved area at the base of the tooth. A gullet may be described using measurements including but not limited to gullet depth and gullet capacity.

As used herein, the term “gullet capacity” means the amount of material removed from a work piece that a gullet can contain.

As used herein, the term “gullet depth” means the distance from the tooth tip to the bottom of the gullet.

As used herein, the term “kerf” refers to the void in a workpiece created by removal of material by the cut of the blade.

As used herein the term “leading” or “leading edge” means a cutting edge of a tooth or blade.

As used herein, the term “material” refers to a metal, ceramic, composite, carbon fiber, alloy, coating or other material or substance known in the art that may be used to form, construct, coat or treat a saw blade.

As used herein, the term “material sensor” refers to any sensor known in the art capable of detecting any differential within a material being cut that may be indicative of the presence of a foreign object.

As used herein, the term “perpendicular axis saw” means a saw that removes material along a perpendicular axis to the piece being cut.

As used herein, the term “perpendicular axis saw blade” refers to a saw blade used for subtractive manufacturing, which moves at a perpendicular axis of movement to axis of movement of the workpiece material being cut.

As used herein, the term “primary” refers to any measurement or characteristic of a primary tooth.

As used herein, the term “primary saw tooth” means a saw tooth that creates a kerf in a workpiece.

As used herein, the term “raker” means a saw blade design with a three-tooth sequence with a uniform set angle (left, right, and straight).

As used herein, the term “saw tooth geometry” includes but is not limited to the following variables and characteristics of a saw tooth: tooth back, tooth face, tooth rake angle and clearance angle.

As used herein, the term “secondary” refers to any measurement or characteristic of a secondary tooth.

As used herein, the term “secondary saw tooth” means a saw tooth which cuts through foreign material in a workpiece.

As used herein, the term “set” refers to the displacement from the centerline of the array of teeth to one or the other side of the centerline of the array of teeth to allow clearance of the body of the blade through the cut.

As used herein, the term “single level set” means a saw blade design where the blade geometry has a single tooth height dimension as a result of bending each tooth at the same position with the same amount of bend on each tooth.

As used herein, the term “skip” means a saw blade design with a wide gullet. A skip blade design may be suited for non-metallic applications such as wood, cork, plastics and composition materials.

As used herein, the term “state” refers to any metric identifying movement, position, speed, structural alteration or damage, location, temperature, structure, friction, lubrication or any other status or state of a system component.

As used herein, the term “subtractive manufacturing” or “subtractive machining” refers to manufacturing or machining processes in which a piece of raw material, such as wood or metal, is cut into a desired final shape and size by a controlled material-removal process.

As used herein, the term “teeth per inch (TPI)” means the number of teeth per inch as measured from tooth tip to tooth tip.

As used herein, the term “thickness gauge” means the dimension from side to side on the blade.

As used herein, the term “tooth back” means the non-leading surface of the tooth, which does not remove material from the workpiece during milling.

As used herein, the term “tooth face” means the leading surface of the tooth, which removes material from the workpiece during milling.

As used herein, the term “tooth pitch” means the distance from the tip of one tooth to the tip of the next tooth.

As used herein, the term “tooth rake angle” or “rake angle” means the angle of the tooth face measured with respect to a line perpendicular to the cutting direction of the saw.

As used herein, the term “tooth set” means the number of teeth per inch and the angle at which they are offset. Tooth set affects cutting efficiency and chip carrying ability.

As used herein, the term “variable design” or “variable positive design” means a saw blade configuration with variable tooth spacing and/or gullet capacity.

As used herein, the term “vari-set” means a saw blade design where the tooth height/set pattern varies with product family and pitch. The teeth have varying set magnitudes and set angles, providing for quieter operation with reduced vibration. Vari-set is efficient for difficult-to-cut materials and larger cross sections.

As used herein, the term “wavy set” means a saw blade design wherein the tooth set varies within groups of teeth set to each side within a set pattern. The teeth have varying amounts of set in a controlled pattern. In various embodiments, a wavy set may reduce noise, vibration and burr when cutting thin, interrupted applications.

As used herein, the term “width” means the dimension of a saw blade as measured from the tip of the furthest-extending tooth to the back of the blade.

As used herein the term “workpiece” means the material being cut, shaped or worked upon.

### DETAILED DESCRIPTION OF THE INVENTION

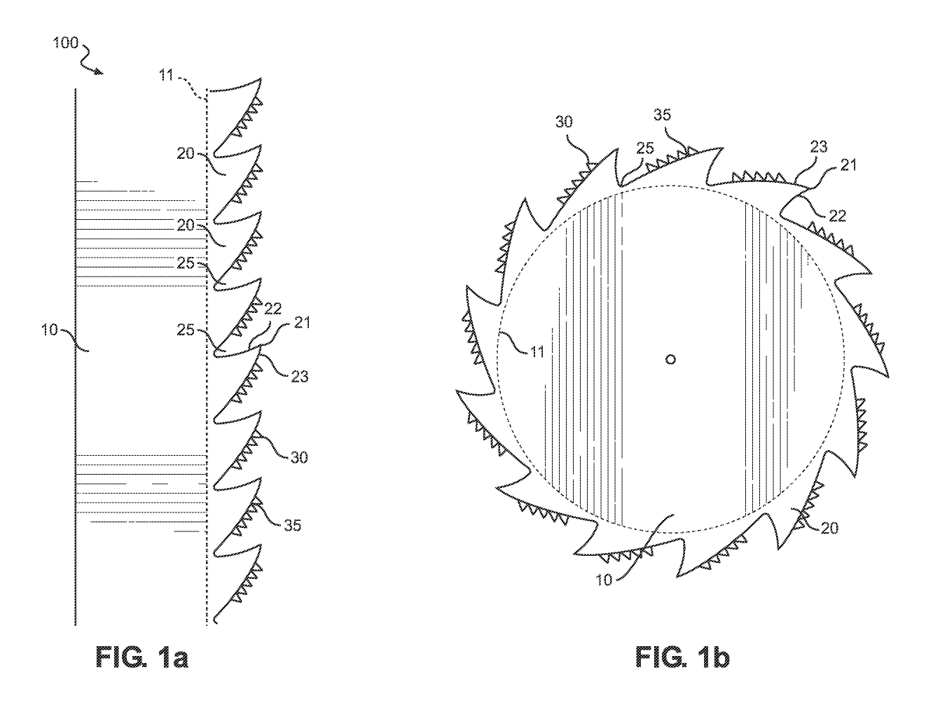

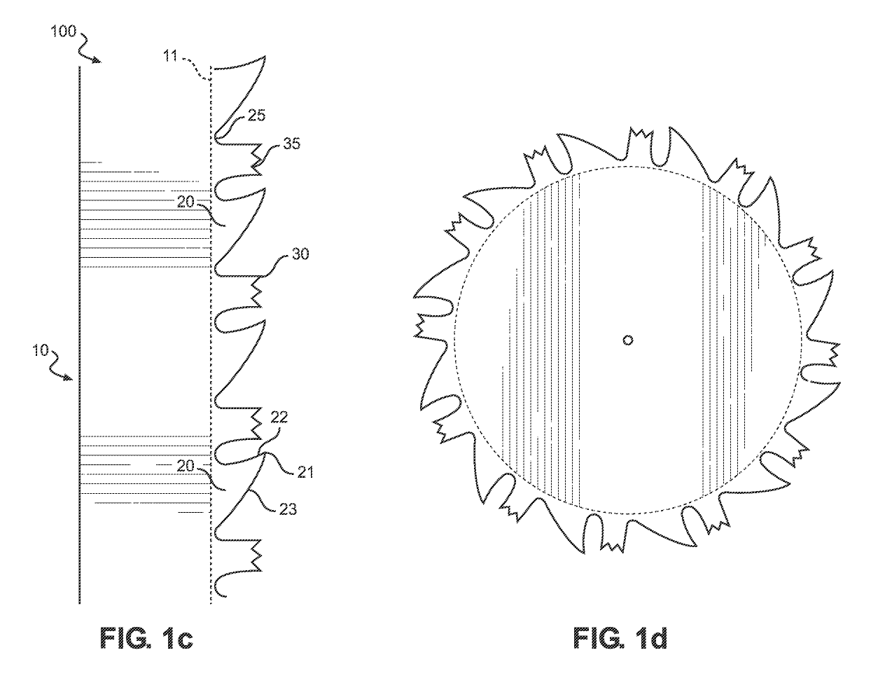

FIGS. 1a, 1b and 1c illustrate alternate embodiments of perpendicular axis saw blade 100. FIGS. 1a and 1c depict configurations of bandsaw blades, while FIG. 1b depicts a rotary saw blade. Perpendicular axis saw blade 100 is designed to cut different materials by being able to cut in either direction.

Perpendicular axis saw blade 100 incorporates a blade body 10, a plurality of primary saw teeth 20 and a plurality of secondary saw teeth 30. Blade body 10 has outer blade body edge 11. Primary saw teeth 20 are designed to cut a workpiece in a primary direction, while secondary saw teeth 30 are designed to cut embedded foreign objects located in the workpiece in a reverse or secondary cutting direction.

Each primary saw tooth 20 attaches to at least one outer blade body edge 11, in a spacing that provide a particular value for primary teeth per inch (TPI) T1. In certain embodiments, T1 is variable. Each primary saw tooth 20 includes a primary tooth tip 21, a primary tooth leading edge 22 and a primary tooth trailing edge 23. Primary gullets 25 extend between the primary tooth trailing edge 23 of one primary saw tooth 20 and the primary tooth leading edge 22 of another primary saw tooth 20. Each primary gullet has a primary gullet depth D1 and a primary gullet capacity C1.

In the embodiment of FIGS. 1a and 1b, a plurality of secondary saw teeth 30 are affixed to primary tooth trailing edge 23, in a spacing that provide a particular value for secondary TPI T2. In certain embodiments, at least one secondary saw tooth 30 is comprised of a different material than at least one primary saw tooth 20. In certain embodiments, T2 is variable. In the exemplary embodiment, T2 is greater than T1. Each secondary gullet 35 extends between one secondary saw tooth 30 and another secondary saw tooth 30. Each secondary gullet 35 has a secondary gullet depth D2 and a secondary gullet capacity C2. In the exemplary embodiment, C1 has a value greater than that of C2 and D1 has a value greater than that of D2.

In the embodiment of FIG. 1c, secondary saw teeth 30 are located between primary saw teeth 20.

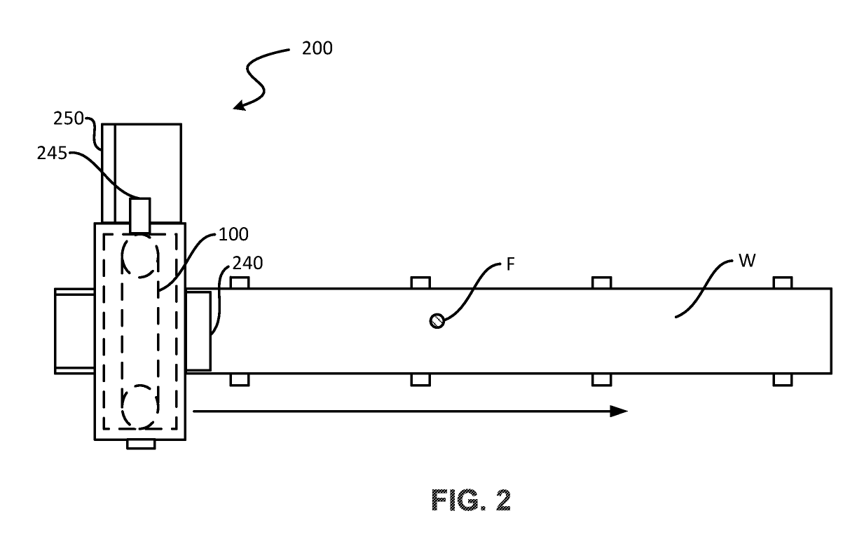

FIG. 2 illustrates an exemplary embodiment of perpendicular axis saw system 200. Each perpendicular axis saw system 200 includes at least one perpendicular axis saw blade 100, as above, at least one material sensor 240, at least one optional status sensor 245 and at least one computer control component 250. This invention is based upon the new perpendicular axis saw blade 100 configuration requiring that perpendicular axis saw blade 100 be able to move in two directions relative to the workpiece. Bandsaws and circular saws are only produced and known to operate in one blade motion or rotation, respectively. Therefore, the concept of running perpendicular axis saw system 200 “backwards” or in such a way as to make a perpendicular axis saw blade 100 move in a reverse or backward motion is considered a part of this invention.

In use, material sensor 240 determines the presence of a foreign object F within a workpiece W. Upon detection, material sensor is configured to transmit at least one alert signal to computer control component 250. In certain embodiments, status sensor 245 identifies a status of perpendicular axis saw blade 100.

Computer control component 250 is configured to receive or process the alert signal and perform at least one saw blade control function. The saw blade control function controls operation of perpendicular axis saw blade 100. In embodiments where perpendicular axis saw blade 100 moves axially, the saw blade control function may reverse the direction of the axial motion or stop the movement entirely. In embodiments where perpendicular axis saw blade 100 moves rotationally, the saw blade control function may reverse the direction of the rotational motion or stop the movement entirely.

In certain embodiments, computer control component 250 performs a rate function utilizing a feed rate of perpendicular axis saw system 200 and a distance X relative to perpendicular axis saw blade 100 to perform a rate control function. This rate control function may be performed before perpendicular axis saw blade 100 contacts the workpiece, and may alter the feed rate to optimize the cutting motion of perpendicular axis saw blade 100.

The workpiece cutting mode of perpendicular axis saw system 200 is provided via perpendicular axis saw blade 100 moving in one cutting direction, which for descriptive purposes will be described as “primary.” The foreign object cutting mode is provided via perpendicular axis saw blade 100 moving in the opposite direction or “secondary.” To utilize perpendicular axis saw blade 100 as described, perpendicular axis saw system 200 has to be able to have a control feature, such as computer control component 250, allowing the selective rotation of its band wheels in a clockwise or counter-clockwise direction of rotation. This is because rotational direction of the band wheels determines the primary or secondary cutting direction of perpendicular axis saw blade 100, which in the case of this invention determines which cutting mode perpendicular axis saw system 200 presents to the workpiece.

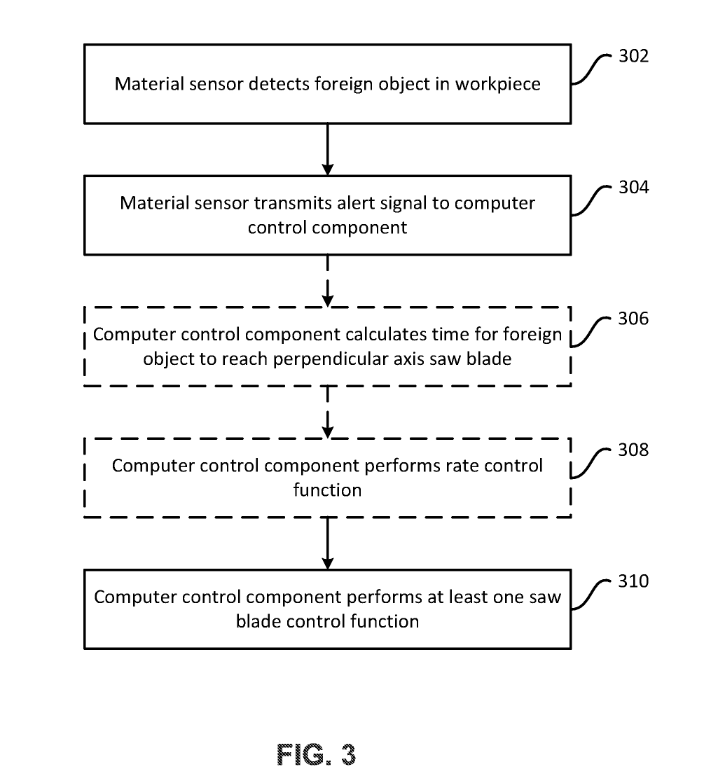

FIG. 3 illustrates the exemplary method 300 for using perpendicular axis saw system 200.

In step 302, material sensor 240 detects a foreign object in a workpiece in perpendicular axis saw system 200.

In step 304, material sensor 240 transmits an alert signal to computer control component 250.

In optional step 306, computer control component 250 calculates the time it will take the foreign object to reach perpendicular axis saw blade 100. In the exemplary embodiment, this calculation is a rate function utilizing a feed rate of perpendicular axis saw system 200 and a distance X of the foreign object relative to perpendicular axis saw blade 100.

In optional step 308, computer control component 250 performs a rate control function to alter the feed rate of perpendicular axis saw system 200.

In step 310, computer control component 250 performs at least one saw blade control function to control operation of perpendicular axis saw blade 100. In one embodiment, the saw blade control function stops the movement of perpendicular axis saw blade 100. In another embodiment, the saw blade control function reverses a direction of movement of perpendicular axis saw blade 100. This reversal may be rotational or along an axis.

It is not normal, nor has a saw been observed or invented, that has a scanner to detect a metal object while cutting a timber so as to control a saw blade's cutting motion. Timber is commonly scanned for metal in industry, but only prior to or after being processed through a saw, not while being sawed. Therefore, the novel method of scanning for imbedded objects to affect the blade cutting direction/rotation while sawing is also a part of this invention.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “about,” “substantially” or “approximately” as used herein may be applied to modify any quantitative representation that could permissibly vary without resulting in a change in the basic function to which it is related.

What is claimed is:

1. A perpendicular axis saw blade comprised of:
a blade body having at least one outer blade body edge to which a plurality of primary saw teeth are affixed at spaced intervals to form a primary teeth per inch (TPI);
a plurality of primary gullets, each of said plurality of primary gullets is located between two of said plurality of primary saw teeth, wherein each primary gullet has a primary gullet depth and primary gullet capacity;
wherein each of said plurality of said primary saw teeth comprises
a primary tooth tip,
a primary tooth leading edge,
a primary tooth trailing edge; and
a plurality of secondary saw teeth affixed to said primary tooth trailing edge at spaced intervals to form a secondary TPI, wherein said primary TPI is different from said secondary TPI.

2. The apparatus of claim 1 wherein each primary saw tooth further includes a plurality of secondary gullets, wherein each of said plurality of secondary gullets is located between two of said plurality of secondary saw teeth.

3. The apparatus of claim 3 wherein each of said plurality of secondary gullets has a secondary gullet depth and a secondary gullet capacity.

4. The apparatus of claim 1 wherein said primary TPI is greater than said secondary TPI.

5. The apparatus of claim 1 wherein said primary TPI is variable.

6. The apparatus of claim 1 wherein said secondary TPI is variable.

7. The apparatus of claim 1 wherein at least one of said plurality of primary saw teeth comprises a first material, wherein at least one of said plurality of secondary saw teeth comprises a second material that is different from said first material.

8. A perpendicular axis saw blade comprised of:
a blade body having at least one outer blade body edge to which a plurality of primary saw teeth are affixed at spaced intervals to form a primary teeth per inch (TPI);
a plurality of primary gullets, each of said plurality of primary gullets is located between two of said plurality of primary saw teeth, wherein each primary gullet has a primary gullet depth and primary gullet capacity,
wherein each of said plurality of said primary saw teeth comprises
a primary tooth tip,
a primary tooth leading edge,
a primary tooth trailing edge; and
a plurality of secondary saw teeth affixed to at least one of said plurality of primary gullets at spaced intervals to form a secondary TPI, wherein said primary TPI is different from said secondary TPI.

9. The apparatus of claim 1 wherein said primary TPI is greater than said secondary TPI.

10. The apparatus of claim 1 wherein said primary TPI is variable.

11. The apparatus of claim 1 wherein said secondary TPI is variable.

12. The apparatus of claim 1 wherein at least one of said plurality of primary saw teeth comprises a first material, wherein at least one of said plurality of secondary saw teeth comprises a second material that is different from said first material.

13. A perpendicular axis saw system for performing subtractive machining on a workpiece comprised of:
at least one material sensor for determining the presence of a foreign object within a workpiece, wherein said at least one material sensor is configured to transmit at least one alert signal when a foreign object has been detected within said workpiece;
at least one computer control component, wherein said at least one computer control component is configured to receive or process said at least one alert signal from said at least one material sensor and to perform at least one saw blade control function to control operation of a perpendicular axis saw blade,
wherein said at least one perpendicular axis saw blade is comprised of:
a blade body having an outer blade body edge to which a plurality of primary saw teeth are affixed at spaced intervals to form a primary teeth per inch (TPI);
a plurality of primary gullets, each of said primary gullet located between two of said plurality of primary saw teeth, wherein each primary gullet has a primary gullet depth and primary gullet capacity,
wherein each of said plurality of said primary saw teeth comprises
a primary tooth tip,
a primary tooth leading edge,
a primary tooth trailing edge, and
a plurality of secondary saw teeth affixed to said primary tooth trailing edge or at least one of said plurality of primary gullets at spaced intervals to form a secondary TPI.

14. The system of claim 13, wherein said at least one saw blade control function comprises reversing a direction of movement of said at least one perpendicular axis saw blade, wherein said direction of movement is rotational.

15. The system of claim 13, wherein said at least one saw blade control function comprises reversing a direction of movement of said at least one perpendicular axis saw blade, wherein said direction of movement is along an axis.

16. The system of claim 13, wherein said at least one saw blade control function comprises stopping a movement of said at least one perpendicular axis saw blade, wherein said movement is rotational.

17. The system of claim 13, wherein said at least one saw blade control function comprises stopping a movement of said at least one perpendicular axis saw blade, wherein said movement is along an axis.

18. The system of claim 13, wherein said at least one computer control component further performs a rate function utilizing a feed rate of said perpendicular axis saw system and a distance relative to said perpendicular axis saw blade to perform a rate control function before said perpendicular axis saw blade comes in contact with said work piece.

19. The system of claim 18, wherein said rate control function includes altering said feed rate of said perpendicular axis saw system.

20. The system of claim 13, further comprising at least one status sensor to identify a status of said at least one perpendicular axis saw blade.
